(19) United States
(12) Patent Application Publication
(10) Pub. No.: US 2007/0215265 A1
(43) Pub. Date: Sep. 20, 2007

(54) Tire Manufacturing Method, Preset Bead Molding Apparatus, and Preset Bead Molding

(76) Inventor: Yoshiyuki Sata, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/574,949

(22) PCT Filed: Oct. 5, 2004
(86) PCT No.: PCT/JP04/14640

§ 371 Date: Feb. 28, 2007

(30) Foreign Application Priority Data
Oct. 7, 2003 (JP) 2003-348223

(51) Int. Cl. B29D 30/00

(52) U.S. Cl. 156/110.1; 156/398

(57) ABSTRACT

There is provided a method of tire manufacturing a tire in which preset-beads each preformed by mounting a bead filler on a bead core are disposed radially outward of a carcass band and both side portions of the carcass band are turned around the preset beads to build the tire. The method eliminates a need to bold the considerable intermediate stocks and does not deteriorate the tire uniformity due to the unevenness of the preset bead in the circumference direction. There are also provided an apparatus of forming a preset bead used therefore and a system of forming a preset bead. In the method of manufacturing a tire in which preset-beads each preformed by mounting a bead filler on a bead core are disposed radially outward of a carcass band and both side portions of the carcass band are turned around the preset beads to build the tire, the preset bead is formed by winding and laminating a ribbon-shaped filler rubber 5 radially outward of the bead core 10 over several laps.

### TECHNICAL FIELD

The present invention relates to a method of manufacturing a tire in which preset beads each preformed by mounting a bead filler on a bead core are disposed radially outward of a carcass band and both side portions of the carcass band are turned around the preset beads to build the tire.

### RELATED ART

Such a tire manufacturing method has been employed that preset-beads each preformed by mounting a bead filler on a bead core are disposed radially outward of a carcass band and both side portions of the carcass band are turned around the preset beads to build the tire (see Patent Document 1, for example). This method has an advantage that can save more space around a building drum and more time necessary for the assembly as compared with the method in which the bead core and the bead filler are separately assembled on a building drum. In this method, particularly when it is used with a so-called drum-flow building system which transfers a building drum from a station to another station and assembles components of a tire in the respective stations, the bead core and the bead filler have to be assembled in the station where the center portion of the carcass band is expanded radially and both side portions of the carcass band are turned around. Therefore, there is a problem that the process in the station needs much time and the cycle time of the whole system is degraded, so it has been practically demanded in actual use.

The preset bead is conventionally formed by winding a rubber having a cross-sectional shape generally identical to that of a green tire over the bead core for only one lap. Though this method has advantages that time required for the winding may be less because the rubber is wound for only one lap, and that the preset bead of this method can be formed by a simple apparatus, this method has below-mentions disadvantages.

First, in this method, a nozzle for the bead filler rubber needs to be b replaced to provide various cross-sectional shapes corresponding to various tire sizes. The replacement, however, is time consuming, so that considerable numbers of the bead fillers with a respective tire size need to be extruded in one time to maintain the operation rate of the extruder. Meanwhile, in the tire manufacturing process which adopts a multiple sizes mixed flow production, tires with a single size are not built in a mass. Thus, it results in unnecessary intermediate stocks of the preset beads, which wastes the space and the management of the intermediate stocks.

Second, in the method in which the bead filler rubber is wound for only one lap, joint portions gathers at one point in the circumference direction. Such a joint portion may cause unevenness in the circumference direction of the preset bead, which may reduce the tire uniformity.

Third, in order to form the bead filler rubber which is linearly extruded and has the above-mentioned cross section into a doughnut-shaped bead filler which extends the radially outward/inward in the cross-section of the tire, the radially outward portion needs to be extended longer than the inward portion does. It is sometimes difficult to make such a extension evenly in the circumferential direction, which is also the cause to reduce the tire uniformity.

Patent Document 1: JP-02-283434-A

### DISCLOSURE OF THE INVENTION

Object to be Solved by the Invention

The present invention has been made in view of the above-mentioned disadvantages and its object is to provide a method of manufacturing a tire in which preset-beads each preformed by mounting a bead filler on a bead core are disposed radially outward of a carcass band and both side portions of the carcass band are turned around the preset beads to build the tire, which method eliminates a need to hold the considerable intermediate stocks and does not deteriorate the tire uniformity due to the unevenness of the preset bead in the circumference direction. Another object of the present invention is to provide a preset bead-forming apparatus used therefore and a preset bead-forming system.

Means for Solving the Problem

The first aspect of the present invention is a method of manufacturing a tire in which preset-beads each preformed by mounting a bead filler on a bead core are disposed radially outward of a carcass band and both side portions of the carcass band are turned around the preset beads to build the tire, wherein said preset bead is formed by winding and laminating a ribbon-shaped filler rubber radially outward of the bead core over several laps.

The second aspect of the present invention is the method of manufacturing a tire according to the first aspect, wherein the ribbon-shaped bead filler rubber is so directed that its thickness direction is aligned to the direction of the central axis of the bead core and the ribbon-shaped bead filler rubber is wound and laminated on a side face of a disk rotating about the central axis of the bead core.

The third aspect of the present invention is an apparatus of forming a preset bead for use in the tire manufacturing method according to the first or second aspect, comprising; a bead core-holding device for holding the bead core; a disk integrally rotating with the bead core-holding device to wind and laminate a ribbon-shaped bead filler rubber on a disk surface; a extruder extruding said ribbon-shaped filler rubber in accordance with its winding; and a ribbon-attaching roller displaceably provided on the disk surface of the disk and pressing the extruded ribbon-shaped bead filler rubber against the disk.

The forth aspect of the present invention is the preset bead-forming apparatus according to the first aspect, wherein the bead core-holding device is composed of magnets which attract and hold the side face of the bead core and a centering device which applies a force to an inner circumference face of the bead core attracted by the magnets to center the bead core, and said apparatus further comprises a ribbon-attaching roller position-controlling means controlling the position of said ribbon-attaching roller.

The fifth aspect of the present invention is a system of forming a preset bead, comprising; the preset bead-forming apparatus according to the forth aspect; a bead core preparing station for preparing bead cores supplied to said preset bead-forming apparatus; a preset bead storage station for temporally storing the formed preset beads; and a bead-handling robot for transferring the bead cores from the bead core-preparing station to the preset bead-forming apparatus as well as transferring the preset beads from the preset bead-forming apparatus to the preset bead storage station.

The sixth aspect of the present invention is the preset bead-forming system according to the fifth aspect, further comprising a system-controlling device for providing a direction of the size of the bead to be prepared to the bead core-preparing station and providing a direction of the size of the preset bead to be formed to the preset bead-forming device on the basis of the predetermined formation order of the preset bead, the order including at least a combination of the preset beads in different sizes which are mutually successive in the order.

The seventh aspect of the present invention is the preset bead-forming system according to the fifth or sixth aspect, further comprising a preset bead inspection station for determining whether the preset bead is good or bad by measuring the weight and shape of the preset bead formed by the preset bead-forming system.

Effect of the Invention

According to the tire manufacturing method of the first aspect, because the bead filler is formed with the ribbon-winding process, the nozzle of the extruder does not need to be replaced for a respective size of the bead filler unlike the method in which a rubber having a cross sectional shape substantially identical to that of the bead filler is wound for only one lap and thus the preset beads having various sizes can be manufactured in a mixed flow process. Therefore, it is possible to reduce the intermediate stocks of the preset beads and to suppress the gathering of the joint portion of the bead filler in the circumferential direction to prevent the uniformity of the product tires from being decreased. Moreover, according to the tire manufacturing method of the second aspect, the preset beads can be formed stably and accurately by laminating the ribbon-shaped bead filler rubber on a disk in parallel with the disk.

According to the tire manufacturing method of the third aspect, the tire manufacturing method of the first or second aspect can be realized and the above-mentioned effect can be achieved.

According to the tire manufacturing method of the forth aspect, because the bead core-holding device is configured as described above, the side face of the bead core is attracted and held on the disk by the magnets and thereafter a force is applied to the inner circumferential face of the bead core by the centering device to center the bead core. Therefore, it is possible to hold and center the bead cores in various sizes without replacing the centering device.

According to the tire manufacturing method of the fifth aspect, by arranging the preset bead-forming apparatus, a bead core-preparing station, a bead-handling robot and a preset bead storage station, transferring of the bead core as well as forming and transferring of the bead core are efficiently and quickly conducted. Therefore, it is possible to save labor and improve the productivity.

According to the tire manufacturing method of the sixth aspect, preset beads in different sizes may be manufactured in a mixed production system. Therefore, it is possible to produce in a large item small lot production.

According to the tire manufacturing method of the seventh aspect, the formed preset beads are inspected and then only non-defective products are supplied to the tire-building apparatus. Therefore, it is possible to supply the preset beads may be supplied to tire-building apparatus with a stable quality.

### BRIEF DESCRIPTION OF THE DRAWINGS

FIG. 1 generally illustrates the preset bead-forming apparatus of the present invention.

FIG. 2 is a schematic cross sectional view of the disk of the preset bead-forming apparatus of the present invention.

FIG. 3 is a schematic view for explaining the preset bead-forming process of the present invention.

FIG. 4 is a schematic plan view showing the layout of the preset bead-forming system of the present invention.

FIG. 5 is a schematic diagram for explaining the operation of the bead removing means of the bead core-preparing station of the present invention.

FIG. 6 is a schematic diagram for explaining a mechanism of the bead-handling robot of the present invention.

### BEST MODE FOR CARRYING OUT THE INVENTION

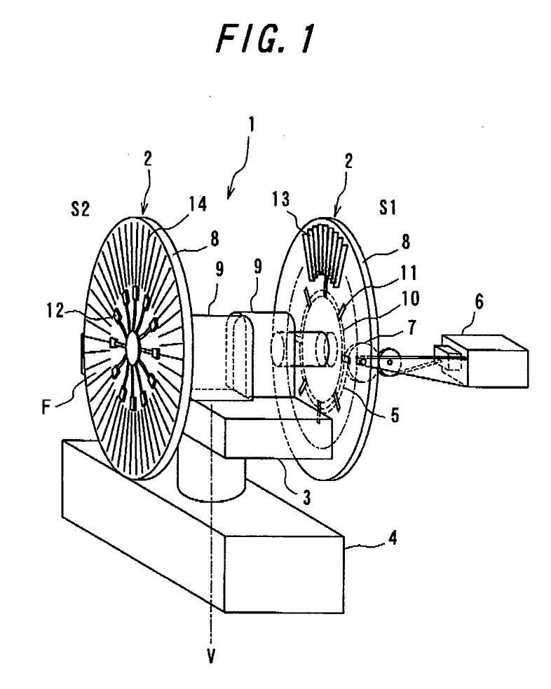

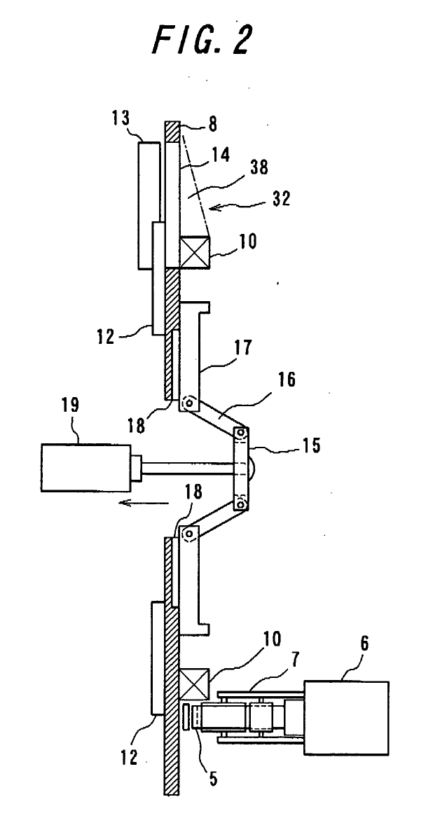

FIG. 1 is a perspective view schematically showing the preset bead-forming apparatus of the present invention and FIG. 2 is a schematic cross-sectional view of the disk of the preset bead-forming apparatus of the present invention taken along the plane including the central axis line. The preset bead-forming apparatus 1 is consist of a pair of bead filler-winding portion 2 for forming a bead filler 38 by winding the ribbon-shaped bead filler rubber 5 for several laps, a common base 3 on which the bead filler-winding parts is mounted, a pivotally driving portion 4 supporting the common base 3 to be able to pivotally drive it with the axis line V as the center line, an extruder 6 extruding the ribbon-shaped filler rubber 5 in accordance with its winding, and ribbon-attaching roller 7 for attaching the extruded ribbon-shaped bead filler rubber 5 to the bead filler-winding part 2. The bead filler-winding parts 2 are so arranged in rotational symmetric positions that they are mutually overlapped when one of them is rotated by 180 degrees around the axis line V. Each of the bead filler winding part 2 is so configured that it reciprocally moves between a bead filler-forming station S1 and a preset bead-removing station S2 by pivoting it. Each bead filler-winding parts 2 has vertically arranged disks 8 with one of their disk surface being an attaching face F onto which the ribbon-shaped rubber 5 is attached, rotationally driving parts 9 rotationally driving the disks 8, magnets 11 which is mounted along the circumferential direction on the surface of the disk 8 opposed to the attaching face F and attracts the side face of the bead core 10 arranged on the attaching face F, a centering device 12 for centering the bead core 10 by applying a force to an inner circumferential face of the bead core attracted and held by the magnets to shift the bead core 10 in relation to the disk 8, and plural of stripping bars 13 extending outwardly and inwardly in the radial direction. The stripping bars pass through slits 14 provided on the disk 8 and displace back and forth in the thickness direction of the disk 8 and penetrating through the slit 14, so that the formed preset bead 32 tightly attached on the attaching surface F is stripped off from the disk 8.

The centering device 12 is composed of a bundling board 15 provided on and displacing along the central axis line of the disk 8, plural of links 16 one end of which is hingedly connected to the bundling board 15, segments 17 connected to the other end of the respective links and applying a force to the inner circumferential face of the bead core attracted and held by the magnets through expansive/contractive displacements, linear guides 18 guiding the displacements of the segments 17 in the radially outward and inward direction, and air cylinder 19 displacing the bundling board 15 in the axial direction of the disk 8. The centering device 12 is so configured that the segments 17 are expansively/contractively displaced through the links 16 by operating the air cylinder 19. In such a centering device 12, any bead cores 10 within the subject range can be centered, regardless of their sizes ranging from the minimum diameter to maximum diameter, by setting the amount of the displacement of the segment 17 in the radial direction of the disk 8. This enables a mixed-flow production in various sizes.

A method of forming preset bead 32 by means of the preset bead-forming apparatus 1 will be discussed below. As is shown in FIG. 1, the bead filler-winding portion 2 is placed on the preset bead-removing station S2 and the bead core 10 is arranged on the attaching face F of the disk 8 with the disk 8 and the bead core 10 being substantially concentric. The bead core 10 thus arranged is attracted and held by the magnets 11. In this state, the bead core 10 may be centered by radially expanding the centering device 12. Then, the common base 3 is pivoted 180 degrees about the axis line V to displace the bead filler-winding part 2 holding said bead filler 10 to the bead filler-forming station S1, where the ribbon-shaped bead filler rubber 5 is wound continuously on the attaching face F radially outward of the bead core 10 while rotating the disk 8. In this way, the bead filler is formed. Thereafter, the bead filler thus formed is pressed against and attached to the bead core 10 by a attaching roll such as a stitcher roll, so that a preset bead is formed. Then the common base 3 is pivoted 180 degrees to displace the bead filler-winding part 2 attracting and holding the preset bead again to the preset bead-removing station S1, where the preset bead 32 is stripped from the disk 8 by the stripping bar 13 to transfer the preset bead to the next process.

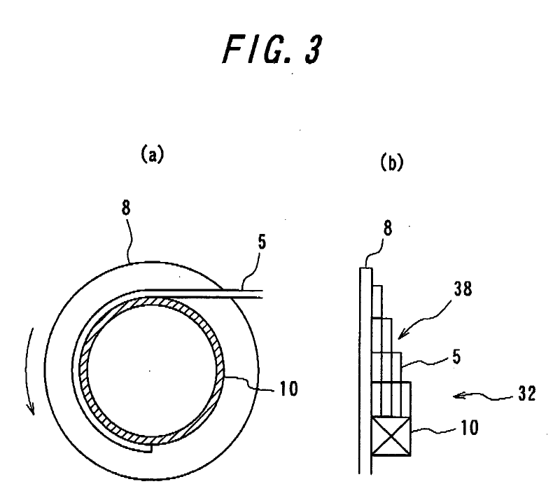

FIG. 3(a) is a schematic view showing an embodiment of the ribbon-shaped filler rubber wound on the disk. A ribbon-shaped filler rubber 5 extruded by the extruder 6 is wound radially outward of the bead core 10 on the disk 8, as is shown in FIG. 3(b). In this example, the ribbon-shaped bead filler rubber 5 is wound for 10 laps in total with being adjacent to the outer circumference of the bead core 10. In a practical process, however, the bead filler 38 is formed by winding the ribbon-shaped bead filler rubber 5 having the width of 6 mm and the thickness of 0.5 mm until approximately 50 layers are laminated. In this way, by winding and laminating a single kind of the ribbon-shaped bead filler 5 with the small width and thickness for many laps, bead fillers 38 having various sizes can be formed in desired shapes.

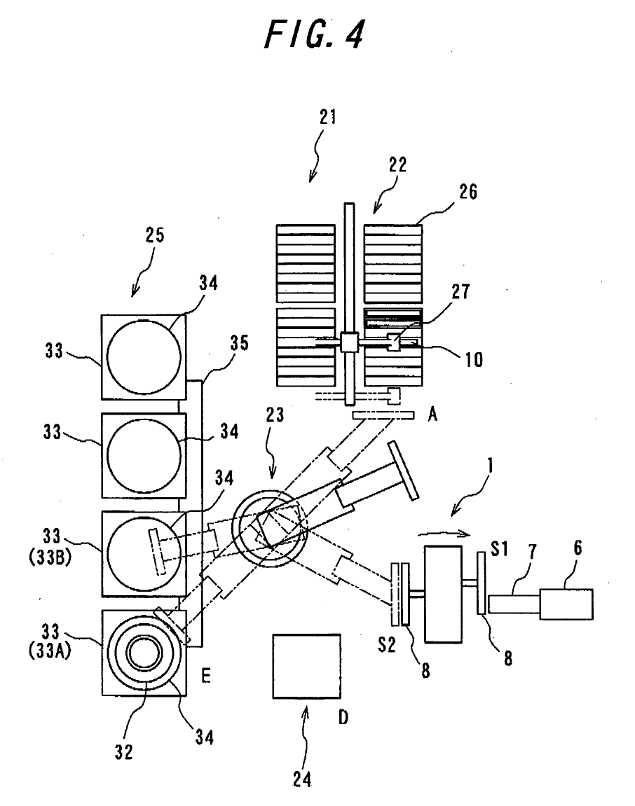

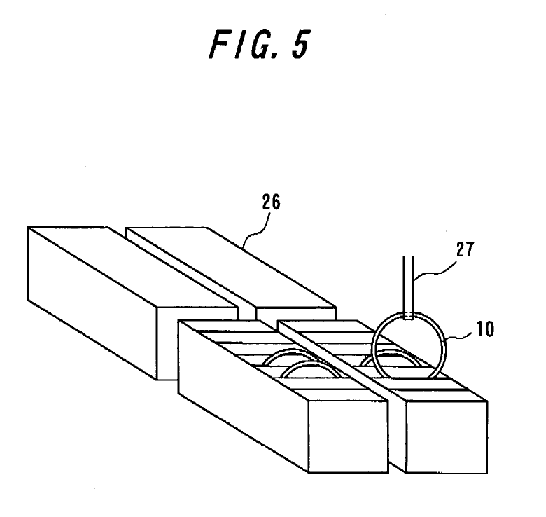

With reference to FIG. 4, the system of forming the preset bead according to the present invention will be explained. The system 21 includes a preset bead-forming apparatus 1; a bead core-preparing station 22 for preparing bead cores supplied to said preset bead-forming apparatus; a bead-handling robot 23 for transferring the bead cores from the bead core-preparing station 22 to the preset bead-forming apparatus 1 as well as transferring the preset beads from the preset bead-forming apparatus 1 to the preset bead storage station 25; a preset bead inspection station 24; and a preset bead storage station 25 for temporally storing the formed preset beads, and each of the components is arranged as shown in the FIG. 4. The bead core preparing station 22 is provided with plural of storage containers 26 each containing bead cores 10 in a mutually different size. A bead core 10 in a size specified by a system-controlling device, which is not shown in the figures, is removed by the bead-removing means 27 from the bead core preparing station 22, as is shown in FIG. 5. The bead core is transferred to the position A by the bead-removing means 25 to pass the bead core to the handling robot 23.

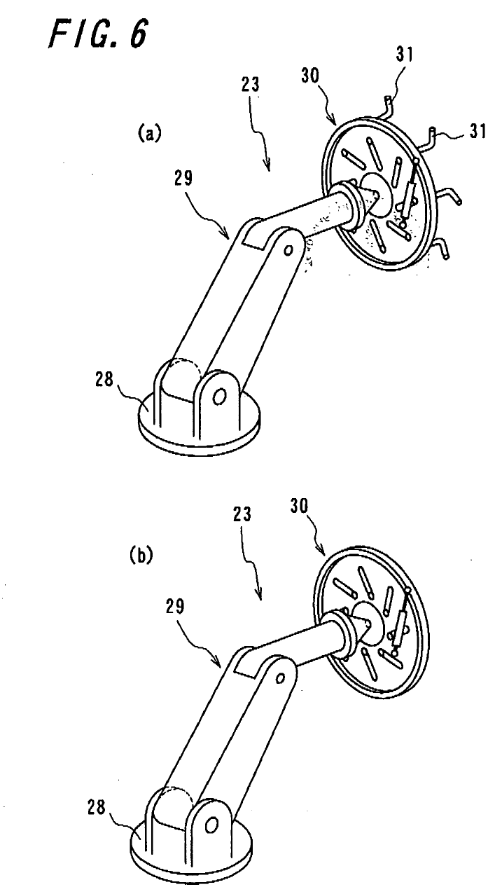

As shown in FIG. 6(a), the handling robot 23 has a base 28 and a multi-joint arm 29,and is pivotally provided with a disk-shaped hand 30 at the tip of the multi-joint arm 29 capable of gripping the bead core 10 and the preset bead. The disk-shaped hand 30 is provided with claw portions 31 which expand/contract outwardly/inwardly in the radial direction and support the bead core from the radially inward direction with its L-shaped corners. As shown in FIG. 6(b), the claw portions 31 is so configured that they can be folded radially inwardly when contracted. The above-mentioned configurations enable the hand 30 to grip the bead cores and the preset beads in various sizes without recognizing their sizes one by one.

Then, the base 28 of the bead handling robot 23 is rotated and the multi-joint arm 29 is stretched/retracted, so that the bead core 10 is passed to the disk 8 of the bead winding part 2 located at the preset bead-removing station S2. Thereafter, by rotating the common base 3 of the preset bead-forming apparatus 1 180 degrees, the preset bead 32 formed in the preset bead forming station S1 is located at the preset bead-removing station S2, where the bead-handling robot 23 receives the preset bead 32.

Then, the preset bead 32 is transferred by bead handling robot 23 to the preset bead inspection station 24 at the position designated by the symbol D in the figure. In the preset bead inspection station 24, the transferred preset bead 37 is inspected for its weight and shape and the accepted product is moved to the loading position E by the bead-handling robot 23 and transferred to a carriage 33A of the preset bead storage station 25.

In the preset bead storage station 25, the preset beads in different sizes formed according to the predetermined formation order are stacked one by one on the carriage 33A with interposing a cartridge 34 therebetween. When the number of the stacked preset bead 32 on the carriage 33A reaches a given number, preset beads is transferred to the tire building apparatus with the carriage as a unit. In FIG. 4, the carriage 33A at the loading position E is still in the course of stacking the preset beads. In this state, only the cartridges 32 are stacked on the other carriage in waiting. After loading a preset bead 32 on the carriage 33A at the loading position E, the bead-handling robot 23 takes out a cartridge from the carriage 33B adjacent to the loading position E and transfers it to the carriage 33A. In this way, the bead-handling robot 23 stacks up preset beads 32 and cartridge 32 alternately. When the number of the preset bead 32 stacked on the carriage 33A reaches a given number, the carriage 33A is discharged and the adjacent carriage 33B is moved to the loading position E, with the only one cartridge left on the dolly 33B.

### EXAMPLES

In order to evaluate an effect on the improvement of the uniformity of a product tire using the preset bead core according to the tire manufacturing method of the present invention, ten tires were experimentally manufactured for each of Example, which was provided with the preset beads manufactured according to the tire manufacturing method of the present invention, and Conventional Example, which was provided with preset beads formed by winding a rubber with a cross sectional shape generally identical to that of the bead filler in the green tire for only one lap. The uniformities of them were measured and compared. As a result, it is shown that the RFV (radial force variation) of the Example tires are smaller than those of the Conventional Example tires by 5N in average. It, therefore, is appreciated that the uniformity of the tire is improved.

1. A method of manufacturing a tire in which preset-beads each preformed by mounting a bead filler on a bead core are disposed radially outward of a carcass band and both side portions of the carcass band are turned around the preset beads to build the tire, wherein said preset bead is formed by winding and laminating a ribbon-shaped filler rubber radially outward of the bead core over several laps.

2. The method of manufacturing a tire according to claim 1, wherein the ribbon-shaped bead filler rubber is so directed that its thickness direction is aligned to the direction of the central axis of the bead core and the ribbon-shaped bead filler rubber is wound and laminated on a side face of a disk rotating about the central axis of the bead core.

3. An apparatus of forming a preset bead for use in the tire manufacturing method according to claim 1, comprising:
a bead core-holding device for holding the bead core;
a disk integrally rotating with the bead core-holding device to wind and laminate a ribbon-shaped bead filler rubber on a disk surface;
an extruder extruding said ribbon-shaped filler rubber in accordance with its winding; and
a ribbon-attaching roller displaceably provided on the disk surface of the disk and pressing the extruded ribbon-shaped bead filler rubber against the disk.

4. The preset bead-forming apparatus according to claim 3, wherein the bead core-holding device is composed of magnets which attract and hold the side face of the bead core and a centering device which applies a force to an inner circumference face of the bead core attracted by the magnets to center the bead core, and said apparatus further comprises a ribbon-attaching roller position-controlling means controlling the position of said ribbon-attaching roller.

5. A system of forming a preset bead, comprising:
a preset bead-forming apparatus;
a bead core preparing station for preparing bead cores supplied to said preset bead-forming apparatus;
a preset bead storage station for temporarily storing the formed preset beads; and
a bead-handling robot for transferring the bead cores from the bead core-preparing station to the preset bead-forming apparatus as well as transferring the preset beads from the preset bead-forming apparatus to the preset bead storage station.

6. The preset bead-forming system according to claim 5, further comprising a system-controlling device for providing a direction of the size of the bead to be prepared to the bead core-preparing station and providing a direction of the size of the preset bead to be formed to the preset bead-forming device on the basis of the predetermined formation order of the preset bead, the order including at least a combination of the preset beads in different sizes which are mutually successive in the order.

7. The preset bead-forming system according to claim 5, further comprising a preset bead inspection station for determining whether the preset bead is good or bad by measuring the weight and shape of the preset bead formed by the preset bead-forming system.

8. An apparatus of forming a preset bead for use in the tire manufacturing method according to claim 2, comprising:
a bead core-holding device for holding the bead core;
a disk integrally rotating with the bead core-holding device to wind and laminate a ribbon-shaped bead filler rubber on a disk surface;
an extruder extruding said ribbon-shaped filler rubber in accordance with its winding; and
a ribbon-attaching roller displaceably provided on the disk surface of the disk and pressing the extruded ribbon-shaped bead filler rubber against the disk.

9. The preset bead-forming apparatus according to claim 8, wherein the bead core-holding device is composed of magnets which attract and hold the side face of the bead core and a centering device which applies a force to an inner circumference face of the bead core attracted by the magnets to center the bead core, and said apparatus further comprises a ribbon-attaching roller position-controlling means controlling the position of said ribbon-attaching roller.

10. The preset bead-forming system according to claim 6, further comprising a preset bead inspection station for determining whether the preset bead is good or bad by measuring the weight and shape of the preset bead formed by the preset bead-forming system.
